(19) United States
(12) Patent Application Publication
(10) Pub. No.: US 2002/0100717 A1
(43) Pub. Date: Aug. 1, 2002

(54) Fuel filters

(76) Inventors: Hironori Ueda, Obu-shi (JP); Takashi Nagai, Obu-shi (JP); Nobuo Suzuki, Obu-shi (JP); Tadao Horiuchi, Obu-shi (JP)

Correspondence Address: DENNISON, SCHEINER, SCHULTZ & WAKEMAN, 612 Crystal Square 4, 1745 Jefferson Davis Highway, Arlington, VA, 22202-3417, US

(21) Appl. No.: 09/774,880

(22) Filed: Feb. 1, 2001

(51) Int. Cl. B01D 35/26

(52) U.S. Cl. 210/116; 210/416.4; 210/436; 210/435

(57) ABSTRACT

A fuel filter apparatus may include a filter case having an exterior surface, a flange extending substantially perpendicularly from the exterior surface having at least one hole, a fuel inlet port and a fuel outlet port. A filter element may be disposed within the filter case between the fuel inlet port and the fuel outlet port. A fuel pump may be disposed within the filter case. A fuel pressure regulator also may be mounted on the fuel filter case. The fuel pressure regulator may have an excess fuel discharge port adapted to discharge excess fuel to the top surface of the filter case. The fuel filter apparatus is adapted to permit the excess fuel to return to a fuel reservoir through the at least one hole and along the exterior surface of the filter case.

### TECHNICAL FIELD

The present invention relates to fuel filters, and more particularly to fuel filters disposed within a fuel tank that permit excess fuel expelled from the fuel pump system to return to the fuel tank via the exterior surface of the fuel filter case when the fuel level in the fuel tank is below the fuel filter case.

### BACKGROUND OF THE RELATED ART

European Patent Application No. 0 852 293 discloses a fuel filter having branch paths that permit fuel to return to the fuel tank via an outer surface of the fuel filter. By returning the fuel to the fuel tank via the outside surface of the fuel filter, static electricity charge build up in the fuel system can be reduced. In addition, Ueda et al, “Electrostatics of Fuel System for the Automobile,” SAE Technical Paper Series (March 1999) teach various techniques for reducing static electricity in the fuel delivery system.

### SUMMARY OF THE INVENTION

It is, accordingly, one object of the present invention to teach improved fuel filters that reduce static electric build up in the fuel system of a vehicle.

In one aspect of the present teachings, fuel filters are taught that provide improved designs for returning excess fuel discharged by a fuel pressure regulator along the exterior of the filter. Such fuel filters may include a filter case having a fuel inlet and a fuel outlet. The filter case may be preferably is adapted to hold a filter element within the filter case. The filter case may be substantially D-shaped or may be another shape, such as cylindrical.

Preferably, excess fuel can be returned to the fuel tank along the exterior of the filter case via holes disposed within a flange that extends perpendicularly, or substantially perpendicularly, with respect to a top surface of the filter case. For example, if excess fuel is discharged from a fuel pressure regulator, because the fuel pressure generated by the fuel pump is too high, the discharged fuel preferably is directed to the top surface of the filter case. The fuel may be directly supplied to the top of the filter case or may be dropped onto the top of the filter case from a position above the filter case. For example, the discharged fuel may be dropped from the fuel pressure regulator directly to the top of the filter case.

Preferably, the filter case may have a rim or wall that extends upwardly (vertically) from a portion of the filter case that is adapted to hold the filter element. Thus, discharged fuel may retained within the top surface of the filter case by the wall. More preferably, the circumference of the vertically extending rim or wall is slightly larger than the circumference of the top surface of the filter case. In that case, the flange may extend outwardly (horizontally) from the top surface of the filter case to support the vertically extending rim or wall.

Holes or apertures may be provided in the outwardly extending flange of the filter case preferably to permit fuel that has collected on the top surface of the filter case to drain from the top surface and return to the fuel reservoir along the exterior surface of the filter case when the fuel level in the fuel reservoir is below the top surface of the filter case. These holes may efficiently direct all or substantially all the returned excess fuel to flow along the exterior of the filter case. In addition, the holes may be disposed so as to direct the excess fuel along the exterior surface of the filter case in a manner that permits the excess fuel to flow along substantially the entire surface of the filter case before reaching the fuel reservoir.

As a result, electric charge on the surface of the filter case will decrease as the discharged excess fuel flows along the exterior surface of the filter case. By reducing electric charge buildup on the surface of the filter case, spark generation can be reduced or prevented. Further, the energy of the return fuel is reduced when returned along the exterior of the filter case, thereby reducing noise that would have been generated if the excess fuel was dropped directly into the fuel tank. Finally, such fuel filter cases can be integrally manufactured at low cost.

In another aspect, the fuel filter is combined with a filter element, which can be sold as a unit. The filter element may be sealed within the filter case during the manufacturing process.

Further, the filter case may be combined with a fuel pump and a fuel pressure regulator and these parts may cooperate to supply fuel from the fuel tank to, for example, a fuel injection system. In one embodiment, the filter case may be adapted to receive the fuel pump within the interior of the filter case. In another embodiment, the filter case may be adapted to adjoin the fuel pump at a lower portion of the filter case. In this case, the excess fuel return path may be lengthened to thereby further reduce static charge in the fuel.

Preferably, an excess fuel discharge port of the fuel pressure regulator is disposed adjacent to the top surface of the filter case. More preferably, the fuel pressure regulator and the filter case are adapted to permit the excess fuel to be returned to the top surface of the filter case by the fuel pressure regulator.

Additional objects, features and advantages of the present invention will be readily understood after reading the following detailed description together with the accompanying drawings and the claims.

### BRIEF DESCRIPTION OF THE DRAWINGS

FIG. 1 shows in interior cross section of a first representative fuel filter.

FIG. 2 shows the exterior of the fuel filter case of FIG. 1.

FIG. 3 shows the exterior of the fuel filter case viewed from the opposite side of the fuel filter case of FIG. 1.

FIG. 4 shows a view of the top surface of the fuel filter case of FIG. 1.

FIG. 5 shows a view of the interior surface the top surface of the fuel filter case of FIG. 1.

FIG. 6 shows the fuel filter of FIG. 1 together with a fuel pump and fuel pressure regulator.

FIG. 7 shows a fuel filter module of a second representative embodiment.

### DETAILED DESCRIPTION OF THE INVENTION

Fuel filter cases are taught that may include a top surface and a bottom surface, which are defined when the filter case is disposed in a generally vertical orientation. An exterior surface preferably extends between the top surface and the bottom surface. A flange may extend perpendicularly, or substantially perpendicularly, from the exterior surface. At least one hole may be formed in the flange, which hole(s) permit(s) excess fuel disposed on the top surface to drain from the top surface. Preferably, the hole(s) is (are) adapted to direct the excess fuel to flow along the exterior surface of the filter case before reaching the fuel reservoir. A fuel inlet port may be provided to receive fuel from the fuel reservoir and a fuel outlet port may be provided to deliver filtered fuel to a fuel injector. Further, a filter element may be disposed within the filter case between the fuel inlet port and the fuel outlet port.

The fuel filter cases may have an inner peripheral wall, which inner peripheral wall has a cylindrical peripheral wall that forms an interior space within the inner peripheral wall. A fuel pump may be connected to the fuel inlet port within the interior space of the filter case. An outer peripheral wall also may be provided, such that the filter element is disposed between the inner peripheral wall and the outer peripheral wall. The fuel filter case is preferably designed to permit fuel to pass through the filter element and enter a fuel outlet chamber formed between the filter element and the inner peripheral wall.

Fuel pump modules are also taught that may include these fuel filter cases. In one embodiment, the fuel filter case may further include a port on the bottom surface and a fuel pump may be mounted to the port. Preferably, excess fuel will flow along an exterior surface of the fuel pump after flowing along the exterior surface of the filter case. In another embodiment, the fuel pump may be disposed within the fuel filter case.

Fuel pump modules may also include a fuel pressure regulator disposed adjacent or proximal to the filter case and in communication with the fuel passage within the filter case. The fuel pressure regulator may have an excess fuel discharge port adapted to discharge excess fuel and direct the excess fuel to the top surface of the filter case.

Preferably, three holes are formed in the flange, although any number of holes may be provided in the flange.

Further, fuel filter cases are also taught that have a top surface and a bottom surface defined when the fuel filter case is disposed in a vertical position. An exterior surface may extend perpendicularly, or substantially perpendicularly, with the top surface and the bottom surface. A fuel inlet port may be provided to receive fuel from a fuel reservoir. A fuel outlet port may be provided to deliver filtered fuel to at least one fuel injector. A space may be provided within the filter case to receive a filter element.

Preferably, a flange extends perpendicularly, or substantially perpendicularly, from the exterior surface and in parallel to the top surface. Moreover, at least one hole is formed in the flange. The hole is positioned so that excess fuel disposed on the top surface of the filter case will return to a fuel reservoir by flowing along the exterior surface. A rim also may optionally extend from the flange in a direction that is generally perpendicular to the top surface of the filter case and in parallel with the exterior surface of the filter case. In the alternative, the hole(s) may be provided in the rim or wall and the flange may be eliminated.

The flange may be disposed on the same plane, or above or below, the top surface of the filter case. The rim or wall may extend above the top surface of the filter case. Further, the top surface, bottom surface, exterior surface, fuel inlet port, fuel outlet port, flange and rim may be integrally formed from a synthetic resin.

A fuel pressure regulator may be coupled to the fuel filter case and in communication with the fuel outlet port. The fuel pressure regulator may sense fuel pressure within the filter case and discharge the excess fuel to the fuel reservoir via the at least one hole in the flange and/or rim and the exterior surface of the filter case.

Further, a fuel pump may be coupled to a port formed in the bottom surface of the filter case. In such case, excess fuel is permitted to return to the fuel reservoir via the exterior surface of the filter case and the fuel pump. In the alternative, the fuel pump may be disposed within the filter case.

Representative examples of the present teachings will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detail description may not be necessary to practice the invention in the broadest sense, and are instead taught merely to particularly describe representative examples of the invention. In addition, the present teachings clearly contemplate that features from one embodiment may be combined with features from another embodiment in order to create additional embodiments, which additional embodiments need not be specifically recited, because such combinations are well within the understanding of a person of ordinary skill in the art.

First Representative Embodiment

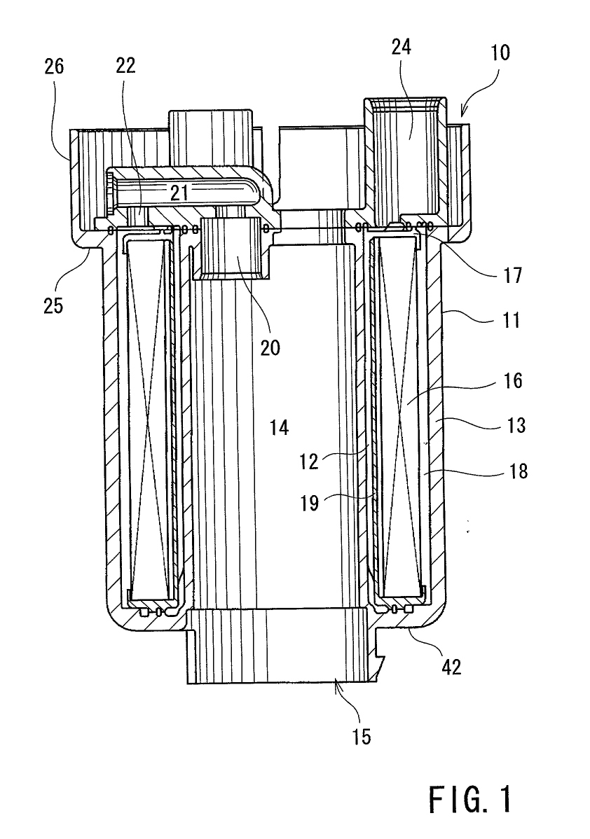

FIG. 1 shows a fuel filter 10 that includes a filter case 11, which filter case 11 may preferably comprise a synthetic resin or other similar material. The filter case may include an inner peripheral wall 12 and an outer peripheral wall 13. The inner peripheral wall 12 may be adapted to receive a fuel pump within the interior 14 of the filter case 11. In the alternative, the interior 14 may be adapted to receive connections between a fuel inlet port 20 and the fuel pump, which also can be mounted below the filter case 11. Thus, port 15 may be adapted to receive the fuel pump or to adjoin the fuel pump if it is disposed below the filter case 11.

The exterior surface of the filter case 11 may preferably have a D-shaped cross-section, although other cross-sections may be utilized. A filter element 16 may be provided between the inner peripheral wall 12 and the outer peripheral wall 13. Preferably, the filter element 16 removes impurities in fuel delivered from the fuel pump using techniques that are well known in the art. The filter element 16 may be a filter medium sheet and can be pleated and curved to have a C-shaped cross-section. However, other filter materials and other shapes may be used. Additional techniques for designing filter element 16, inner peripheral wall 12 and outer peripheral wall 13 are described in U.S. Pat. No. 5,900,140, which is incorporated herein in its entirety.

A sealing member 17 may be provided to divide the interior of the filter case into a fuel inlet chamber 18, which is formed on the outer peripheral side of the filter element 16, and a fuel outlet chamber 19, which is formed on the inner peripheral side of the filter element 16. The construction of the sealing member 17 may be modified in accordance with the construction of the filter element 16 that is used. For example, if the filter element 16 is a C-shaped, pleated filter medium sheet, the sealing member 17 is preferably adapted to seal the inside peripheral surface and the outside peripheral surface of the filter element 16. On the other hand, if the filter element is an O-shaped, cylindrical filtering medium, the sealing member may be adapted to seal the axial upper part and the axial lower part of the filter element. Moreover, the filter element 16 or the filter case 11 may have an integrally formed seal, thereby obviating the need for sealing member 17.

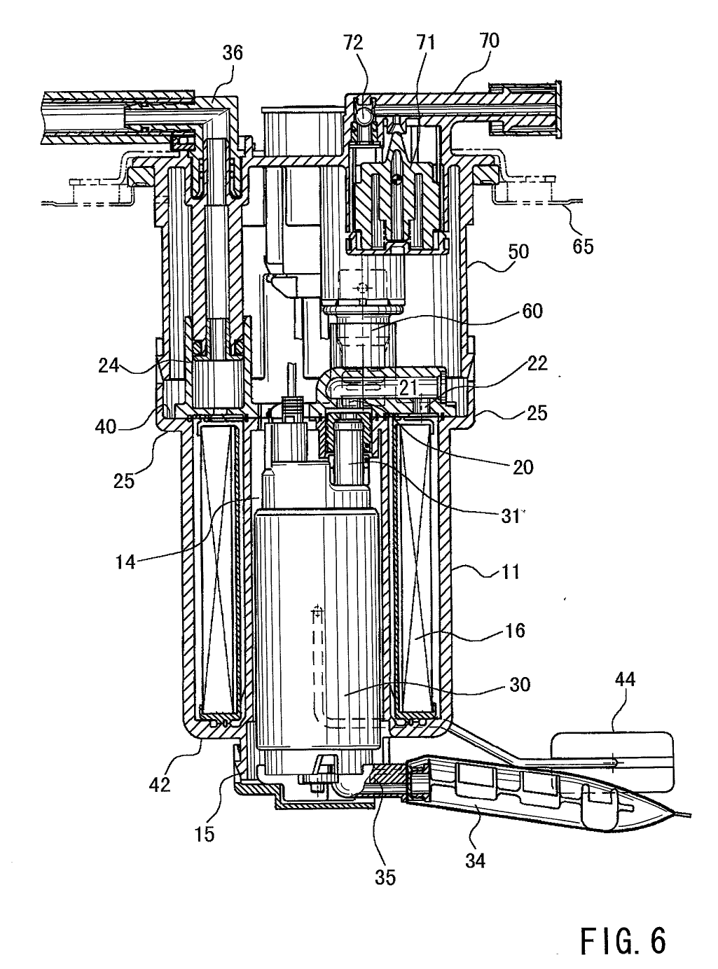

Fuel inlet mounting port 20 is preferably provided within the interior 14 of the filter case and is adapted to receive pressurized fuel from the fuel pump. As shown in FIG. 6 for example, fuel pump 30 may have a delivery port 31 that is adapted to be connected to the fuel inlet mounting port 20 of the filter case 11. Fuel inlet mounting port 20 preferably communicates through a fuel path 21 and a fuel inlet port 22 with the fuel inlet chamber 18.

An outlet mounting hole 24 is also provided and is adapted to connect to a fuel supply pipe (not shown) adapted to supply fuel to a main fuel delivery pipe (not shown). This fuel delivery pipe preferably supplies pressurized, filtered fuel to at least one fuel injector (not shown) of a vehicle engine. The outlet mounting hole 24 may communicate with the fuel outlet chamber 19.

A flange 25 preferably extends perpendicularly, or substantially perpendicularly, from the exterior surface of filter case 11. A wall 26 extends perpendicularly, or substantially perpendicularly, from flange 25. Thus, wall 26 is preferably parallel, or substantially parallel with the exterior surface of filter case 11. In this representative embodiment, flange 25 extends from the top surface 40 of the filter case 11, although flange 25 may be disposed above or below top surface 40. Further, in this embodiment, wall 26 extends above the top surface of filter case 11, although the top edge of wall 26 may be disposed even with or below the top surface 40 of the filter case 11, if the flange 25 is disposed below the plane of the top surface 40 of the filter case 11.

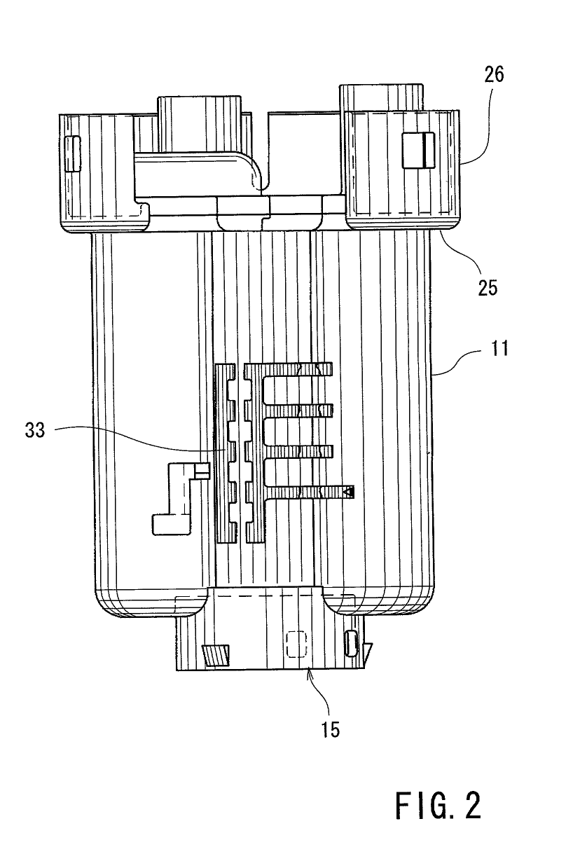

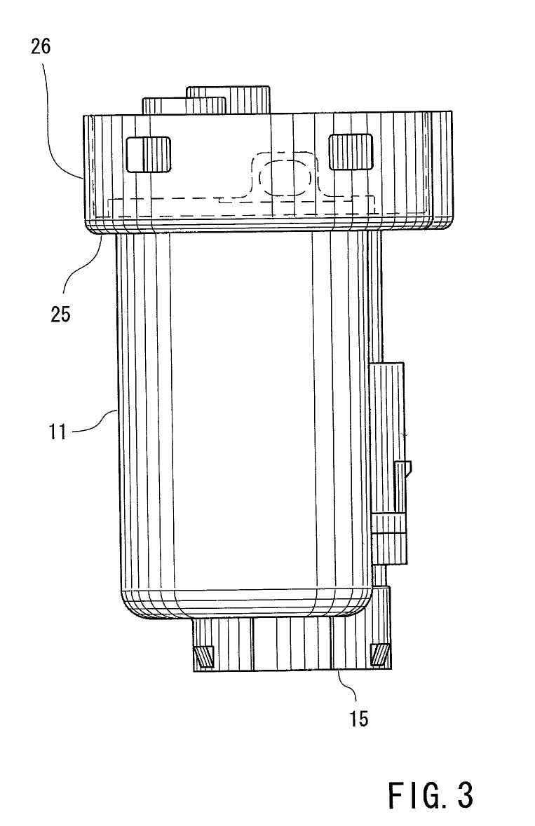

Opposite sides of the exterior of filter case 11 are shown by FIGS. 2 and 3. An attachment mount 33 may optionally be provided to support a sensor or other equipment that may be necessary for the fuel delivery system.

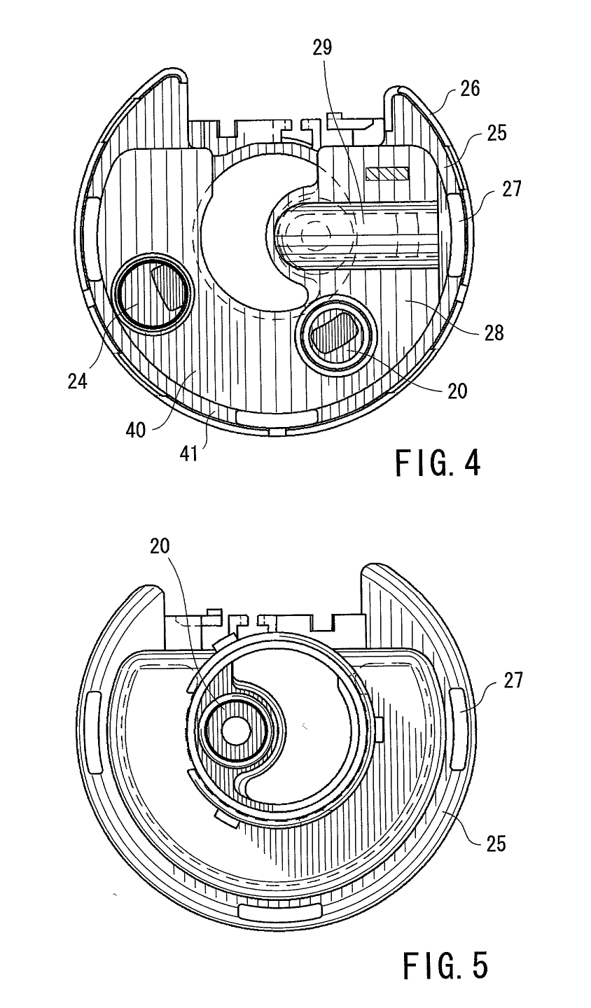

FIG. 4 shows a top view of top surface 40 of filter case 11. In this embodiment, three holes or apertures 27 are formed in the flange 25. These holes 27 are adapted to permit excess fuel, which has been returned to the top surface 40 of the filter case 11 by a fuel pressure regulator, to return to the fuel tank via the exterior surface of filter case 11. The exterior surface 29 of fuel path 21 is shown. A raised portion 28 may be provided on the top surface 40 in order to define a well 41 between the raised portion 28 and the wall 26. Thus, excess fuel retained on top surface 40 by wall 26 can collect within well 41 before returning to the fuel reservoir via holes 27. Although three holes 27 are shown in FIG. 4, it is only necessary to provide one hole 27. However, more or less than three holes 27 may be provided. Preferably, the holes 27 are disposed in a manner that will permit the excess fuel to flow along the entire exterior surface, or substantially the entire exterior surface, of filter case 11 in order to maximize the static electricity reduction effects of this design.

FIG. 5 shows a bottom view of top surface 40 of filter case 11, which view includes flange 25 and holes 27. As noted above, fuel inlet mounting port 20 is adapted to receive pressurized fuel from a fuel pump.

FIG. 6 shows a pump module in which a fuel pump 30, a fuel regulator 60 and other elements are assembled with the fuel filter. In this embodiment, fuel pump 30 is inserted into filter case 11 via port 15 in the bottom surface 42 of filter case 11. Fuel pump 30 has a delivery port 31 that is coupled to the inlet mounting port 20 via a pipe 32. Optionally, a sensor or other equipment (not shown) can be inserted in the interior 14 of the filter case 11. Thus, the pump module, including any attachments, can be partially inserted into the fuel tank 65 through a hole in the fuel tank 65.

The fuel pressure regulator 60 may be provided to regulate the pressure of the pressurized fuel within filter case 11 in order to deliver fuel at an appropriate pressure to the fuel injectors. If the pressure of the fuel is too high, the fuel pressure regulator 60 can release or discharge excess fuel in order to reduce the fuel pressure. The fuel pressure regulator 60 may have a fuel discharge port (not shown) to communicate return excess fuel to the top surface 40 of the filter case 11. As noted above, a fuel delivery pipe (not shown) may be connected to the pressurized fuel port 36 in order to couple the pump module to the fuel injectors (not shown). The fuel pressure regulator 60 also may be coupled to pressurized fuel port 36 in order to release excess fuel and thus deliver fuel at an appropriate pressure to the fuel injectors.

Further, a suction filter 34 may be connected to a fuel intake port 35 of the fuel pump 30. Thus, the pump module, which includes fuel filter 10, fuel pump 30 and suction filter 34, can be inserted through the tank hole into the fuel tank 65. The suction filter 34 may be disposed within the fuel tank 65 so that the suction filter 34 always contacts the bottom surface of the fuel tank 65. By disposing the suction filter 34 in this manner, static electric charge buildup can be further reduced. Additional techniques for designing suction filter 34 are described in U.S. Pat. Nos. 5,120,434 and 5,607,578, which patents are each incorporated herein in their entirety.

The fuel pump module of FIG. 6 also includes an optional set plate 50 for retaining various accessories that are disposed above the filter case 11. In this embodiment, fuel pressure regulator 60 may be disposed within set plate 50 and can be coupled to fuel inlet port 20 in order to regulate the fuel pressure before it enters the filter element 16. If the fuel pressure regulator 60 detects a high-pressure situation, excess fuel is preferably discharged via the fuel pressure regulator 60 to the top surface 40 of the filter case. Excess fuel will collect on the top surface 40, because wall 26 will retain the fuel. Further, holes 27 are provided in flange 25 in order to direct the excess fuel along the exterior surface of filter case 11.

Fuel cut-off valve 71 optionally may be disposed above the filter case 11. Fuel within the fuel reservoir may evaporate and cause the pressure within the fuel tank 65 to increase. Therefore, port 70 may be provided to direct evaporated fuel emissions to a canister (not shown). The canister may help to reduce fuel vapor emissions when the vehicle is not operating. However, if the vehicle (and fuel filter module) is tilted from the usual position, liquid fuel may flow out through port 70 to the canister. Therefore, fuel cut-off valve 71 may be provided to prevent liquid fuel from flowing out through port 70 when the vehicle is in a tilted position. The fuel cut-off valve 71 may normally be open, but will close if the surface of the liquid fuel reaches a pre-determined level. If the liquid fuel reaches the pre-determined level, the fuel cut-off valve 71 will close to prevent liquid fuel from flowing to the canister. A relief valve 72 may also be optionally provided to regulate vapor pressure within the fuel tank 65.

Further, a fuel level gauge 44 may be provided to sense the amount of fuel in the fuel tank 65.

As noted above, fuel pump 30 may be disposed within the filter case 11. In such case, delivery port 31 may optionally be directly coupled to fuel inlet port 20. Further, other accessories may instead be disposed above filter case 11, instead of within filter case 11. This representative embodiment provides a compact design, which may be useful to conserve space.

A representative method for operating the fuel pump module will now be described. Fuel is pressurized by the fuel pump 30 and then delivered to the delivery port 31. The pressurized fuel then passes through the filter case 11 via the fuel path 21, the fuel inlet port 22, the fuel inlet chamber 18, the filter element 16, fuel outlet chamber 19, and the fuel outlet port 23. The filtered and pressurized fuel is then delivered to the pressurized fuel port 36. If the pressure of the fuel is too high, excess fuel is discharged via the fuel discharge port of the fuel pressure regulator 60 to the top surface 40 of the filter case 11.

For example, the excess fuel discharged from the pressure regulator 60 may be dropped onto raised portion 28 and then collect in well 41. Due to gravity, the excess fuel will fall through holes 27 and flow down along the exterior surface the filter case 11 to the fuel reservoir. It will be understood that the exterior surface of the filter case 11 may be exposed to the fuel reservoir. In this case, a housing is not necessary to surround the filter case 11. However, a housing may be provided and the excess fuel will return to the fuel reservoir between the filter case 11 and the housing.

In this representative embodiment because the excess fuel flows down along the exterior surface of the filter case 11, static electric charge on the surface of the filter case 11 is reduced. In addition, the kinetic energy of the return fuel is reduced, because of the energy absorbing effect caused by allowing the excess fuel to flow along the exterior surfaces of the filter case 11. Therefore, the amount of noise generated by returning excess fuel to the fuel reservoir can be minimized.

Second Representative Embodiment

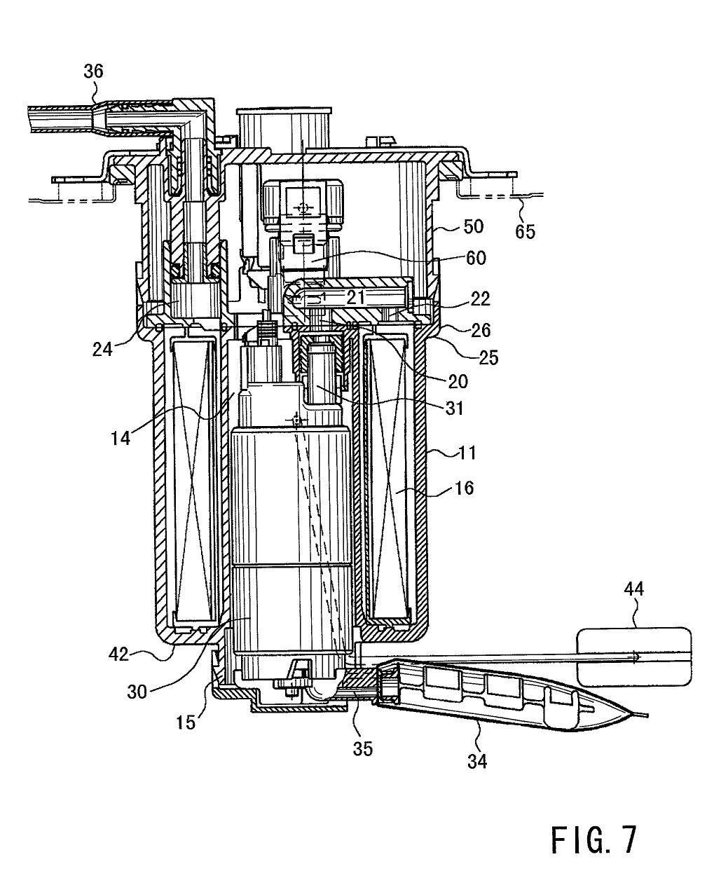

FIG. 7 shows another representative embodiment of the present teachings, in which the fuel pump 30 is again mounted within the filter case 11 and a fuel pressure regulator 60 is disposed above the top surface 40 of the filter case 11. In the second representative embodiment, the fuel cut-off valve 71, discharge port 70 and relief valve 72 are not included to realize a more compact design. Because the second representative embodiment is basically a modification of the first embodiment, the same reference numerals have been utilized for elements that are identical in each embodiment and description of unmodified elements will not be repeated.

Further techniques for reducing static electricity build up are taught in Ueda et al, “Electrostatics of Fuel System for the Automobile,” SAE Technical Paper Series (March 1999) and this reference is incorporated herein by reference in its entirety. In addition, commonly assigned U.S. Pat. Nos. 6,024,072, 6,126,387 and 6,156,201 and U.S. application Ser. Nos. 09/380,590, 09/576,343 and 09/558,850 are also incorporated herein by reference in their entirety.

1. A fuel filter case, comprising:
a top surface and a bottom surface defined when the filter case is disposed in a generally vertical orientation,
an exterior surface extending substantially perpendicularly between the top surface and the bottom surface,
a flange extending substantially perpendicularly from the exterior surface, wherein at least one hole is formed in the flange and the at least one hole is adapted to permit excess fuel disposed on the top surface to return to a fuel reservoir by flowing along the exterior surface,
a fuel inlet port adapted to receive fuel from a fuel reservoir,
a fuel outlet port adapted to deliver filtered fuel to at least one fuel injector and
a filter element disposed within the filter case between the fuel inlet port and the fuel outlet port.

2. A fuel filter case as in claim 1, further comprising:
an inner peripheral wall having a cylindrical peripheral wall that forms an interior space within the inner peripheral wall, wherein the fuel inlet port is disposed within the interior space of the filter case and is adapted to connect to a fuel pump and
an outer peripheral wall, wherein the filter element is disposed between the inner peripheral wall and the outer peripheral wall, and the fuel filter case is adapted to permit fuel to pass through the filter element and enter a fuel outlet chamber formed between the filter element and the inner peripheral wall.

3. A fuel pump module comprising:
the fuel filter case of claim 2 and
a fuel pump mounted disposed within the fuel filter case.

4. A fuel pump module as in claim 3 further comprising a fuel pressure regulator mounted on the filter case in communication with the fuel outlet port, wherein the fuel pressure regulator is adapted to discharge excess fuel to the top surface of the filter case.

5. A fuel pump module comprising the fuel filter case of claim 1 and a fuel pressure regulator mounted on the filter case in communication with the fuel outlet port, wherein the fuel pressure regulator is adapted to discharge excess fuel to the top surface of the filter case.

6. An apparatus, comprising:
a filter case having a top surface, exterior surface substantially perpendicular to the top surface, a flange extending substantially perpendicularly from the exterior surface, a fuel inlet port and a fuel outlet port, wherein the filter case comprises at least one hole within the flange and the at least one hole is adapted to direct fuel disposed on the top surface to a fuel reservoir along the exterior surface,
a filter element disposed within the filter case between the fuel inlet port and the fuel outlet port, and
a fuel pressure regulator mounted to the filter case, wherein the fuel pressure regulator is adapted to discharge excess fuel to the top surface of the filter case.

7. An as in claim 6, wherein at least three holes are formed in the flange.

8. An apparatus as in claim 7, wherein the filter case further comprises a wall extending perpendicularly from the flange, wherein the wall is adapted to retain fuel on the top surface of the filter case.

9. An apparatus as in claim 8, wherein the holes are adapted to direct the fuel to return along substantially the entire exterior surface of the filter case.

10. A fuel filter case, comprising:
a top surface and a bottom surface defined when the fuel filter case is disposed in a vertical position,
an exterior surface extending substantially perpendicularly to the top surface and the bottom surface,
a fuel inlet port adapted to receive fuel from a fuel reservoir,
a fuel outlet port adapted to deliver filtered fuel to at least one fuel injector,
a space adapted to receive a filter element,
a flange extending substantially perpendicularly from the exterior surface and in parallel to the top surface, wherein at least one hole is formed in the flange and the at least one hole is adapted to permit excess fuel on the top surface to return to a fuel reservoir along the exterior surface and
a rim extending generally perpendicularly from the flange.

11. A filter case as in claim 10, wherein the flange is disposed on the same plane, or slightly below the top surface of the filter case.

12. A filter case as in claim 10, wherein the top surface, bottom surface, exterior surface, fuel inlet port, fuel outlet port, flange and rim are integrally formed from a synthetic resin.

13. A fuel filter apparatus comprising:
the fuel filter case of claim 12 and
a fuel pressure regulator in communication with the fuel outlet port and the at least one hole, wherein the fuel pressure regulator is adapted to sense fuel pressure at the fuel outlet port and discharge excess fuel to the fuel reservoir via the at least one hole and the exterior surface of the filter case.

14. A fuel filter apparatus as in claim 13 further comprising a fuel pump disposed within the filter case.

15. A fuel filter apparatus comprising:
the fuel filter case of claim 11 and
a fuel pressure regulator in communication with the fuel outlet port and the at least one hole, wherein the fuel pressure regulator is adapted to sense fuel pressure at the fuel outlet port and discharge the excess fuel to the fuel reservoir via the at least one hole and the exterior surface of the filter case.

16. A fuel filter apparatus as in claim 15 further comprising a fuel pump disposed within the filter case.

17. A fuel filter apparatus comprising:
the fuel filter case of claim 10 and
a fuel pressure regulator in communication with the fuel outlet port and the at least one hole, wherein the fuel pressure regulator is adapted to sense fuel pressure at the fuel outlet port and discharge the excess fuel to the fuel reservoir via the at least one hole and the exterior surface of the filter case.

18. A fuel filter apparatus as in claim 17 further comprising a fuel pump disposed within the filter case.

19. A fuel filter apparatus comprising:
the fuel filter case of claim 10,
a set plate adapted to be fitted into a mounting hole of a fuel tank, wherein the set plate is attached to the fuel filter case,
a fuel cut-off valve coupled with the set plate and
a fuel vapor discharge port integrally formed with the set plate and coupled to the fuel cut off valve.

20. A filter case as in claim 10, further comprising a raised portion disposed on the top surface of the filter case, wherein raised portion, the top surface of the filter case, the flange and the rim define a well adapted to retain excess fuel on the top surface of the filter case and direct the excess fuel to the at least one hole.
